(19) United States
(12) Patent Application Publication
(10) Pub. No.: US 2025/0314407 A1
(43) Pub. Date: Oct. 9, 2025

(54) REFRIGERANT ACCUMULATOR

(71) Applicant: ConocoPhillips Company, Houston, TX (US)

(72) Inventors: Michael Calderon, Houston, TX (US); Will T. James, Houston, TX (US); Karl Bezyack, Houston, TX (US)

(21) Appl. No.: 19/081,259

(22) Filed: Mar. 17, 2025

Related U.S. Application Data
(60) Provisional application No. 63/574,444, filed on Apr. 4, 2024.

(51) Int. Cl. F25B 43/00; B01D 19/00; F25B 9/00; F25J 1/02

(52) U.S. Cl. CPC F25B 43/006; B01D 19/0042; F25B 9/002; F25J 1/0262

(57) ABSTRACT

A refrigerant accumulator operable to receive a refrigerant. The refrigerant accumulator may include a plurality of elongated pipes. The plurality of pipes may include a first portion of the plurality of pipes disposed on a first plane and a second portion of the plurality of pipes disposed on a second plane.

### CROSS-REFERENCE TO RELATED APPLICATIONS

The present application claims priority to U.S. Provisional Patent Application No. 63/574,444 filed on Apr. 4, 2024, which is incorporated by reference in its entirety herein.

### FIELD

The present disclosure relates to liquefied natural gas (LNG) facilities and more particularly to a liquefied natural gas (LNG) facility employing a refrigerant accumulator.

### BACKGROUND

Refrigerant accumulators typically are used for a number of functions within an LNG facility. Conventional refrigerant accumulators are vessels capable of receiving a one-phase or two-phase fluid stream, such as, for example, a flash vessel, a horizontally-elongated separation vessel, or a vertically-elongated separation vessel. However, these conventional refrigerant accumulators require large spaces to accommodate the size and elevation requirements.

### SUMMARY

Implementations described and claimed herein provide an improved refrigerant accumulator that is capable of reducing size and elevation requirements when used within LNG facilities.

In one implementation, a method for separating a refrigerant stream, the method comprising: receiving a portion of a refrigerant stream by a refrigerant accumulator, separating the refrigerant stream by the refrigerant accumulator into a first refrigerant portion and a second refrigerant portion, the first refrigerant portion comprising vapor and the second refrigerant portion comprising liquid, withdrawing the first refrigerant portion from the refrigerant accumulator via a first conduit, and withdrawing the second refrigerant portion from the refrigerant accumulator via a second conduit.

In another implementation, a system comprising a refrigerant accumulator operable to receive a refrigerant, a plurality of pipes of the refrigerant accumulator, a first portion of the plurality of pipes disposed on a first plane and operable to receive the refrigerant to separate the refrigerant into a first refrigerant portion and a second refrigerant portion, the first refrigerant portion comprising vapor and the second refrigerant portion comprising liquid, and a second portion of the plurality of pipes disposed on a second plane and operable to receive the first refrigerant portion.

In another implementation, the plurality of pipes may include a manifold, junction, tee, wye, elbow, riser, loop, U or S trap, sediment trap, or other structure.

The foregoing is intended to be illustrative and is not meant in a limiting sense. Many features of the implementations may be employed with or without reference to other features of any of the implementations. Additional aspects, advantages, and/or utilities of the present disclosure will be set forth in part in the description that follows and, in part, will be apparent from the description, or may be learned by practice of the present disclosure.

### BRIEF DESCRIPTION OF THE DRAWINGS

The foregoing summary, as well as the following detailed description, will be better understood when read in conjunction with the appended drawings. For the purpose of illustration, there is shown in the drawings certain implementations of the present disclosure. It should be understood, however, that the present disclosure is not limited to the precise implementations and features shown. The accompanying drawings, which are incorporated in and constitute a part of this specification, illustrate an implementation of apparatuses consistent with the present disclosure and, together with the description, serve to explain advantages and principles consistent with the present disclosure.

FIG. 1 is a diagram illustrating an example cascade-type LNG facility;

FIG. 2 is a flow chart of an example method for separating a refrigerant stream.

### DETAILED DESCRIPTION

The following detailed description references the accompanying drawing that illustrates various implementations of the present disclosure. The illustration and description are intended to describe aspects and implementations of the present disclosure in sufficient detail to enable those skilled in the art to practice the present disclosure. Other components can be utilized and changes can be made without deviating from the scope of the present disclosure. The following detailed description is, therefore, not to be taken in a limiting sense. The scope of the present disclosure is defined only by the appended claims, along with the full scope of equivalents to which such claims are entitled.

The phraseology and terminology employed herein are for the purpose of description and should not be regarded as limiting. For example, the use of a singular term, such as, “a” is not intended as limiting of the number of items. Also, the use of relational terms such as, but not limited to, “top,” “bottom,” “left,” “right,” “upper,” “lower,” “down,” “up,” and “side,” are used in the description for clarity in specific reference to the figures and are not intended to limit the scope of the present disclosure or the appended claims. The term “automatic,” “automatically,” or any variation thereof is used in the description to describe performing a subsequent action without any assistance, interference, and/or input from a human. Further, it should be understood that any one of the features of the present disclosure may be used separately or in combination with other features. Other systems, methods, features, and advantages of the present disclosure will be, or become, apparent to one with skill in the art upon examination of the figures and the detailed description. It is intended that all such additional systems, methods, features, and advantages be included within this description, be within the scope of the present disclosure, and be protected by the accompanying claims.

The present disclosure is described below with reference to operational illustrations of methods and devices. It is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of various steps in a sample order and are not necessarily meant to be limited to the specific order or hierarchy presented.

Further, as the present disclosure is susceptible to implementations of many different forms, it is intended that the present disclosure be considered as an example of the principles of the present disclosure and not intended to limit the present disclosure to the specific implementations shown and described. Any one of the features of the present disclosure may be used separately or in combination with any other feature. References to the terms “implementation,” “implementations,” and/or the like in the description mean that the feature and/or features being referred to are included in, at least, one aspect of the description. Separate references to the terms “implementation,” “implementations,” and/or the like in the description do not necessarily refer to the same implementation and are also not mutually exclusive unless so stated and/or except as will be readily apparent to those skilled in the art from the description. For example, a feature, structure, process, step, action, or the like described in one implementation may also be included in other implementations but is not necessarily included. Thus, the present disclosure may include a variety of combinations and/or integrations of the implementations described herein. Additionally, all aspects of the present disclosure, as described herein, are not essential for its practice. Likewise, other systems, methods, features, and advantages of the present disclosure will be, or become, apparent to one with skill in the art upon examination of the figures and the description. It is intended that all such additional systems, methods, features, and advantages be included within this description, be within the scope of the present disclosure, and be encompassed by the claims.

The term “coupled” is defined as connected, whether directly or indirectly through intervening components, and is not necessarily limited to physical connections. The connection can be such that the objects are permanently connected or releasably connected. The terms “comprising,” “including” and “having” are used interchangeably in this disclosure. The terms “comprising,” “including” and “having” mean to include, but not necessarily be limited to the things so described. The term “real-time” or “real time” means substantially instantaneously.

Lastly, the terms “or” and “and/or,” as used herein, are to be interpreted as inclusive or meaning any one or any combination. Therefore, “A, B or C” or “A, B and/or C” mean any of the following: “A,” “B” or “C”; “A and B”; “A and C”; “B and C”; “A, B and C.” An exception to this definition will occur only when a combination of elements, functions, steps or acts are in some way inherently mutually exclusive.

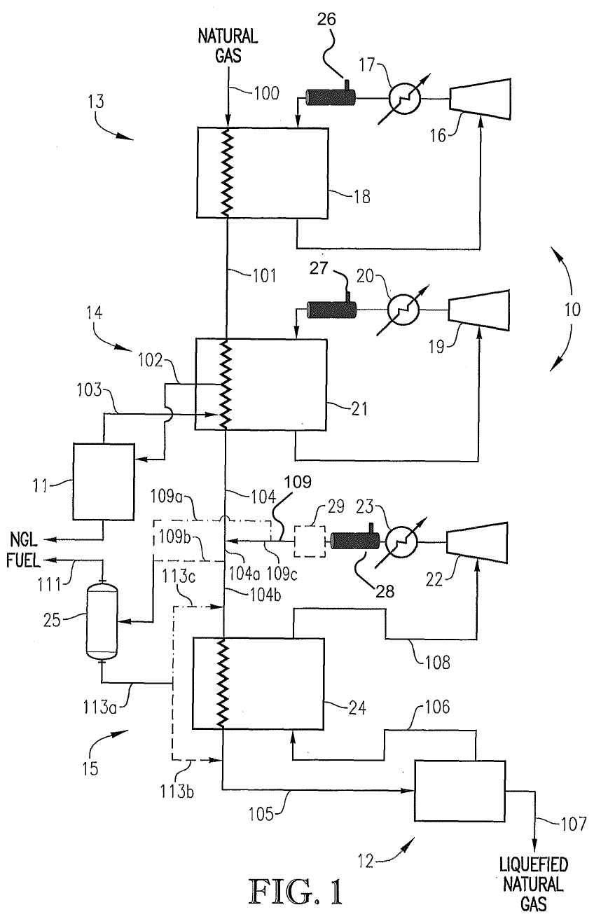

FIG. 1 illustrates a simplified cascade-type LNG facility. The cascade-type LNG facility of FIG. 1 includes a cooling section 10, a heavies removal section 11, and an expansion cooling section 12. In an implementation, the cooling section 10 includes a first refrigeration cycle 13, a second refrigeration cycle 14, and a third refrigeration cycle 15. The first, second, and third refrigeration cycles 13, 14, 15 can be closed-loop refrigeration cycles, open-loop refrigeration cycles, or any combination thereof. In one implementation, as illustrated in FIG. 1, the first and second refrigeration cycles 13 and 14 are closed-loop cycles, and the third refrigeration cycle 15 is an open-loop cycle that utilizes a refrigerant.

In an implementation, the first, second, and third refrigeration cycles 13, 14, 15 employ first, second, and third refrigerants, such as, for example, propane, ethylene, and methane. In an implementation, the first, second, and third refrigerants respectively have successively lower boiling points. For example, the first, second, and third refrigerants can have mid-range boiling points at standard pressure (i.e., mid-range standard boiling points) within about 10° C. (18° F.), within about 5° C. (9° F.), or within 2° C. (3.6° F.) of the standard boiling points of propane, ethylene, and methane, respectively. In one implementation, the first refrigerant can comprise at least about 75 mole percent, at least about 90 mole percent, at least 95 mole percent, or can consist essentially of propane, propylene, methane, or mixtures thereof. The second refrigerant can comprise at least about 75 mole percent, at least about 90 mole percent, at least 95 mole percent, or can consist essentially of ethane, ethylene, or mixtures thereof. The third refrigerant can comprise at least about 75 mole percent, at least about 90 mole percent, at least 95 mole percent, or can consist essentially of methane.

As shown in FIG. 1, the first refrigeration cycle 13 includes a first cooler 17 and a first refrigerant chiller 18, according to an implementation. In this implementation, a first refrigerant compressor 16 discharges a stream of compressed first refrigerant, which subsequently is cooled and at least partially liquefied in the first cooler 17. The resulting refrigerant stream then enters a first refrigerant accumulator 26 that separates the refrigerant stream into a non-condensible gas portion and a liquid portion. The liquid portion is directed into the first refrigerant chiller 18, where at least a portion of the liquid portion cools the incoming natural gas stream in conduit 100 via indirect heat exchange. A gaseous refrigerant exits the first refrigerant chiller 18 and then routed to an inlet port of the first refrigerant compressor 16 to be recirculated.

The first refrigerant accumulator 26 serves a number of functions. In one implementation, the first refrigerant accumulator 26 facilitates more efficient separation in the heavies removal section 11, by, for example, allowing one or more distillation columns in the heavies removal section 11 to operate more efficiently at a lower pressure. In another implementation, the first refrigerant accumulator 26 provides sufficient surge time to allow the operators to maintain system control and stability during process upsets by providing adequate surge time for the refrigerant used in the refrigerant cycles.

In an implementation, the first refrigerant accumulator 26 is composed of a plurality of elongated pipes (i.e., fingers). In an implementation, the plurality of pipes may include a manifold, junction, tee, wye, elbow, riser, loop, U or S trap, sediment trap, or other structure. The plurality of pipes are divided into at least first and second portions. The first portion of the plurality of pipes is disposed on a first plane, and the second portion of the plurality of pipes is disposed on a second plane. In an implementation, the first plane is spaced vertically and/or parallel from the second plane. In this implementation, the plurality of pipes include a third portion that connect the first and second portions of the plurality of pipes. In an implementation the third portion of the plurality of pipes is disposed in a third plane. In an implementation, the third plane is arranged perpendicular to the first and/or second planes. In an implementation the first portion of the plurality of pipes are operable to receive the refrigerant stream to separate the refrigerant stream into a first refrigerant portion and a second refrigerant portion. In this implementation, the first refrigerant portion includes vapor, such as, for example, a non-condensible gas, and the second refrigerant portion includes liquid. In this implementation, the second portion of the plurality of pipes are operable to receive the first refrigerant portion.

In the implementation where the first plane is spaced vertically from the second plane, the first refrigerant accumulator 26 is operable to separate the fluid stream introduced via from the first cooler 17 into the liquid portion and the non-condensible gas portion using gravity. Examples of non-condensible gases can include, but are not limited to, hydrogen, helium, nitrogen, neon, oxygen, carbon monoxide, carbon dioxide, argon, air, and the like. In one implementation, the first refrigerant accumulator 26 can have a separation efficiency of at least about 25 percent, at least about 50 percent, at least about 75 percent, or at least 80 percent.

The first refrigerant accumulator 26 can provide enough refrigerant surge time to allow the operators of LNG facility to react to drastic process changes while still maintaining system stability. In one implementation, the first refrigerant accumulator 26 can have a volume sufficient to provide at least about 2 minutes, 2.25 minutes, 2.5 minutes, 2.75 minutes, 3 minutes, 3.25 minutes, 3.5 minutes, 4 minutes, or 5 minutes of residence time in the accumulator. Residence time in the accumulator is determined by the size and shape of the pipe volume and may be adjusted based on the desired design. For instance, pipe volume may be adjusted by increasing or decreasing the diameter and length of the pipe to achieve a specific volume for the accumulator. If additional length is required a manifold, junction, tee, wye, elbow, riser, loop, U or S trap, sediment trap, or other structure may be incorporated to achieve a specific volume for the first refrigerant accumulator 26. In another implementation, the accumulator may provide at least about 5 minutes, at least about 10 minutes, or at least about 15 minutes, or at least 30 minutes of surge time. This is in direct contrast to other conventional systems, which can be highly sensitive to drastic changes in facility operating conditions.

In an implementation, the first refrigerant chiller 18 includes one or more cooling stages operable to reduce the temperature of the incoming natural gas stream in conduit 100 by an amount in the range of from about 20° C. (36° F.) to about 120° C. (216° F.), about 25° C. (45° F.) to about 110° C. (198° F.), or 40° C. (72° F.) to 85° C. (153° F.). The natural gas entering the first refrigerant chiller 18 via conduit 100 has a temperature in the range of from about −20° C. (−4° F.) to about 95° C. (203° F.), about −10° C. (14° F.) to about 75° C. (167° F.), or 10° C. (50° F.) to 50° C. (122° F.). The temperature of the cooled natural gas stream exiting first refrigerant chiller 18 can be in the range of from about −55° C. (−67° F.) to about −15° C. (5° F.), about −45° C. (−49° F.) to about −20° C. (−4° F.), or −40° C. (−40° F.) to −30° C. (−22° F.). The pressure of the natural gas stream in conduit 100 can be in the range of from about 690 kPa (100.1 psi) to about 20,690 kPa (3,000.8 psi), about 1,725 kPa (250.2 psi) to about 6,900 kPa (1,000.8 psi), or 2,760 kPa (400.3 psi) to 5,500 kPa (797.7 psi). Because the pressure drop across the first refrigerant chiller 18 can be less than about 690 kPa (100.1 psi), less than about 345 kPa (50 psi), or less than 175 kPa (25.4 psi), the cooled natural gas stream in conduit 101 can have substantially the same pressure as the natural gas stream in conduit 100.

In an implementation, the cooled natural gas stream exiting the first refrigeration cycle 13 enters the second refrigeration cycle 14, which includes a second refrigerant compressor 19, a second cooler 20, a second refrigerant accumulator 27, and a second refrigerant chiller 21. Compressed refrigerant is discharged from the second refrigerant compressor 19 and subsequently cooled and at least partially liquefied in the second cooler 20 prior to entering the second refrigeration cycle 14 that separates the refrigerant stream into a non-condensible gas portion and a liquid portion. The liquid portion is directed into the second refrigerant chiller 21. The second refrigerant chiller 21 employs a plurality of cooling stages to progressively reduce the temperature of the cooled natural gas stream in conduit 101 by an amount in the range of from about 30° C. (54° F.) to about 100° C. (180° F.), about 35° C. (63° F.) to about 85° C. (153° F.), or 50° C. (90° F.) to 70° C. (126° F.) via indirect heat exchange. A gaseous refrigerant exits the second refrigerant chiller 21 and then routed to an inlet port of the second refrigerant compressor 19 to be recirculated in the second refrigeration cycle 14.

The natural gas feed stream in conduit 100 will usually contain ethane and heavier components (C2+), which can result in the formation of a C2+ rich liquid phase in one or more of the cooling stages of the second refrigeration cycle 14. In order to remove the undesired heavies material from the predominantly methane stream prior to complete liquefaction, at least a portion of the natural gas stream passing through the second refrigerant chiller 21 can be withdrawn via conduit 102 and processed in the heavies removal section 11, as shown in FIG. 1. The stream in conduit 102 can have a temperature in the range of from about −110° C. (−166° F.) to about −45° C. (−49° F.), about −95° C. (−139° F.) to about −50° C. (−58° F.), or −85° C. (−121° F.) to −65° C. (−85° F.). The stream in conduit 102 can have pressure that is within about 5 percent, about 10 percent, or 15 percent of the pressure of the natural gas feed stream in conduit 100.

In an implementation, the heavies removal section 11 includes one or more gas-liquid separators operable to remove at least a portion of the heavy hydrocarbon material from the cooled natural gas stream. The heavies removal section 11 can be operated to remove benzene and other high molecular weight aromatic components, which can freeze in subsequent liquefaction steps and plug downstream process equipment. In addition, the heavies removal section 11 is operated to recover the heavy hydrocarbons in a natural gas liquids (NGL) product stream. Examples of hydrocarbon components included in NGL streams can include ethane, propane, butane isomers, pentane isomers, and hexane and heavier components (i.e., C6+). The extent of NGL recovery from the cooled natural gas stream ultimately impacts one or more final characteristics of the LNG product, such as, for example, Wobbe index, BTU content, higher heating value (HHV), ethane content, and the like. In one implementation, the NGL product stream exiting the heavies removal section 11 is subjected to further fractionation in order to obtain one or more pure component streams. Often, NGL product streams and/or their constituents can be used as gasoline blendstock.

In an implementation, a heavies-depleted, cooled natural gas stream is withdrawn from the heavies removal section 11 via conduit 103 and can be routed back to the second refrigeration cycle 14. The stream in conduit 103 can have a temperature in the range of from about −100° C. (−148° F.) to about −40° C. (−40° F.), about −90° C. (−130° F.) to about −50° C. (−58° F.), or −80° C. (−112° F.) to −55° C. (−67° F.). The pressure of the stream in conduit 103 can be in the range of from about 1,380 kPa (200.15 psi) to about 8,275 kPa (1200.2 psi), about 2,420 kPa (351 psi) to about 5,860 kPa (849.9 psi), or 3,450 kPa (500.4 psi) to 4,830 kPa (700.5 psi).

In an implementation, the cooled natural gas stream in conduit 103 is further cooled via the second refrigerant chiller 21. The stream exiting second refrigerant chiller 21 via conduit 104 can be completely liquefied and can have a temperature in the range of from about −135° C. (−211° F.) to about −55° C. (−67° F.), about −115° C. (−175° F.) to about −65° C. (−85° F.), or −95° C. (−139° F.) to −85° C. (−121° F.). The stream in conduit 104 can be at approximately the same pressure the natural gas stream entering the LNG facility in conduit 100.

In an implementation, the stream in conduit 104 combines with a stream in conduit 109 prior to entering the third refrigeration cycle 15. The third refrigeration cycle 15 includes a third refrigerant compressor 22, a third cooler 23, a third refrigerant accumulator 28, and a third refrigerant economizer 24. Compressed refrigerant discharged from the third refrigerant compressor 22 enters the third cooler 23, where the refrigerant stream is cooled via indirect heat exchange prior to entering the third refrigerant accumulator 28 that separates the refrigerant stream into a non-condensible gas portion and a liquid portion. The liquid portion is directed into a cooling zone 29. In an implementation, the cooling zone 29 includes one or more cooling stages operable to cool and at least partially condense the stream in conduit 109. In an implementation, the cooling zone 29 can be at least partly defined within one or more of the first or second refrigerant chillers 18, 21 and/or within third refrigerant economizer 24. When a portion of the cooling zone 29 is defined within one or more of the first, second, and third refrigeration cycles 13, 14, 15, the respective refrigeration cycles can define one or more additional cooling passes.

In an implementation where the third refrigeration cycle 15 includes an open-loop refrigeration cycle, the cooled stream exiting the cooling zone 29 is split into two portions. In this implementation, the first portion, illustrated by dot-dashed line 109a, is routed into a separation vessel 25, while the second portion, represented by the solid line 109c, is combined with the stream withdrawn from the second refrigerant chiller 21 in conduit 104. In an implementation, the separation vessel 25 is a multi-stage separation vessel that includes a number of trays and/or amount of packing.

The first portion routed to the separation vessel 25 includes at least a portion, a major portion, or substantially all of the stream exiting the cooling zone 29. In another implementation, substantially none of the stream exiting the cooling zone 29 is routed to separation vessel 25 and substantially all of the stream exiting the cooling zone 29 is combined with the cooled stream exiting the second refrigerant chiller 21 in conduit 104.

In an implementation, the combined stream in conduit 104a, which may or may not comprise at least a portion of the compressed stream exiting the cooling zone 29, is split into a third portion and a fourth portion. According to an implementation, the third portion, depicted by dashed line 109b, is routed to the separation vessel 25, while the fourth portion, illustrated by conduit 104b, enters the third refrigerant economizer 24. In an implementation, the third portion routed to the separation vessel 25 includes at least a portion, a major portion, or substantially all of the combined stream in conduit 104a, while, in another implementation, substantially none of the stream in conduit 104 is routed to the separation vessel 25, such that a substantial portion of the combined stream in conduit 104 enters third refrigerant economizer 24.

In an implementation, an incondensable-depleted product stream is withdrawn from separation vessel 25 via conduit 113 a. The incondensable-depleted product stream in conduit 113 a can then be routed to the inlet (via conduit 113 c) and/or outlet (via conduit 113 b) of the third refrigerant economizer 24.

In an implementation, the third refrigerant economizer 24 includes one or more cooling stages operable to further cool the stream in conduit 104 via indirect heat exchange with the refrigerant. In an implementation, the temperature of the stream in conduit 105 can be reduced by an amount in the range of from about 2° C. (3.6° F.) to about 35° C. (63° F.), about 3° C. (5.4° F.) to about 30° C. (54° F.), or 5° C. (9° F.) to 25° C. (45° F.) in the third refrigerant economizer 24. The temperature of the stream exiting the third refrigerant economizer 24 can be in the range of from about −170° C. (−274° F.) to about −55° C. (−67° F.), about −145° C. (−229° F.) to about −70° C. (−94° F.), or −130° C. (−202° F.) to −85° C. (−121° F.).

In an implementation, the stream exiting the third refrigerant economizer 24 is then routed to expansion cooling section 12, where the stream can be at least partially subcooled via sequential pressure reduction to near atmospheric pressure by passage through one or more expansion stages. The expansion cooling section 12 can comprise from 1 to 6, 2 to 5, or 3 to 4 expansion stages. Each expansion stage can reduce the temperature of the stream by an amount from about 5° C. (9° F.) to about 35° C. (63° F.), about 7.5° C. (13.5° F.) to about 30° C. (54° F.), or 10° C. (18° F.) to 25° C. (45° F.). Each expansion stage includes one or more expanders, which reduce the pressure of the liquefied stream to thereby evaporate or flash a portion thereof. Examples of suitable expanders can include, but are not limited to, Joule-Thompson valves, venturi nozzles, flashing liquid expanders (FLE), and turboexpanders. The expansion cooling section 12 can reduce the pressure of the stream in conduit 105 by an amount in the range of from about 520 kPa (75.4 psi) to about 3,100 kPa (449.6 psi), about 860 kPa (124.7 psi) to about 2,070 kPa (300.2 psi), or 1,030 kPa (149.4 psi) to 1,550 kPa (224.8 psi).

Each expansion stage may additionally employ one or more vapor-liquid separators operable to separate the vapor phase (i.e., the flash gas stream) from the stream. At least a portion of the flash gas stream exiting the expansion cooling section 12 can be used as a refrigerant to cool at least a portion of the stream in conduit 104. Generally, when third refrigerant cycle 15 comprises an open-loop cycle, the third refrigerant can comprise at least 50 weight percent, at least about 75 weight percent, or at least 90 weight percent of flash gas from the expansion cooling section 12, based on the total weight of the stream. The flash gas exiting the expansion cooling section 12 via conduit 106 can enter the third refrigerant economizer 24, where the stream can cool at least a portion of the stream entering the third refrigerant economizer 24 via conduit 104. The resulting warmed refrigerant stream can then exit the third refrigerant economizer 24 via conduit 108 and can thereafter be routed to an inlet port of the third refrigerant compressor 22. The third refrigerant compressor 22 discharges a stream of compressed third refrigerant, which is thereafter cooled in the third cooler 23. The resulting cooled stream in conduit 109 can then be further cooled in the cooling zone 29 before combining with the stream in conduit 104 prior to entering the third refrigerant economizer 24, as previously discussed.

In an implementation, the liquid stream exiting expansion section 12 via conduit 107 can comprise LNG. The LNG in conduit 107 can have a temperature in the range from about −130° C. (−202° F.) to about −185° C. (−301° F.), about −145° C. (−229° F.) to about −170° C. (−274° F.), or −155° C. (−247° F.) to −165° C. (−265° F.) and a pressure in the range from about 0 kPa (0 psia) to about 345 kPa (50 psia), about 35 kPa (5.1 psia) to about 210 kPa (30.5 psia), or 82.7 kPa (12 psia) to 210 kPa (30.5 psia).

The LNG in conduit 107 can comprise at least about 85 volume percent of methane, at least about 87.5 volume percent methane, at least about 90 volume percent methane, at least about 92 volume percent methane, at least about 95 volume percent methane, or at least 97 volume percent methane. In another implementation, the LNG in conduit 107 can comprise less than about 15 volume percent ethane, less than about 10 volume percent ethane, less than about 7 volume percent ethane, or less than 5 volume percent ethane. In another implementation, the LNG in conduit 107 can have less than about 2 volume percent C3+ material, less than about 1.5 volume percent C3+ material, less than about 1 volume percent C3+ material, or less than 0.5 volume percent C3+ material. The LNG in conduit 107 can subsequently be routed to storage and/or shipped to another location via pipeline, ocean-going vessel, truck, or any other suitable transportation means. In one implementation, at least a portion of the LNG can be subsequently vaporized for pipeline transportation or for use in applications requiring vapor-phase natural gas.

In an implementation, the second 27 and third 28 refrigerant accumulators are substantially similar to the first refrigerant accumulator 25. It should be understood, that the first 26, second 27, and third 28 refrigerant accumulators could be placed in a variety of locations proximate the first 17, second 20, and third 23 coolers in addition to the locations illustrated in FIG. 1. In an implementations, the first 26, second 27, and third 28 refrigerant accumulators are more “pipe-like” and are behind or under one or more of the first 18, second 21, and 24 chillers. In an implementation, one or more of the first 26, second 27, and third 28 refrigerant accumulators are disposed at an angle relative to the first 17, second 20, and third 23 coolers. Although each refrigeration cycle 13, 14, and 15 is illustrated as having a respective refrigerant accumulator 26, 27, 28, the disclosure is not limited as such. For instance, in another implementation, a single refrigerant accumulator is fed by all three refrigeration cycles 13, 14, and 15.

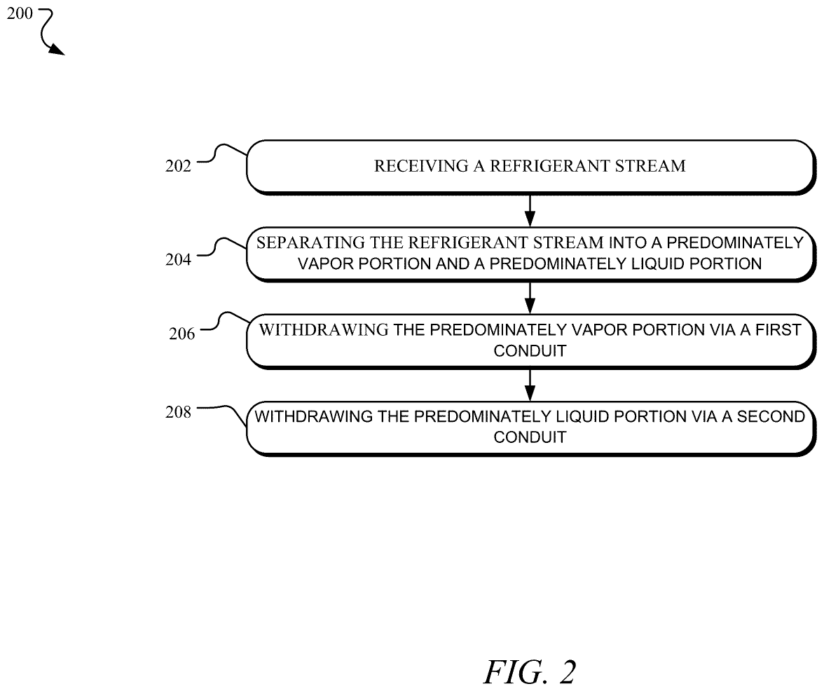

Turning to FIG. 2, a method 200 for separating a refrigerant stream is shown. The method 200 is provided by way of example, as there are a variety of ways to carry out the method. The method 200 described herein can be carried out using the configurations and examples illustrated in the figures, for example, and various elements of these figures are referenced in explaining the method 200. Each block shown in FIG. 2 represents one or more processes, methods, or subroutines, carried out in the method 200. Furthermore, the illustrated order of blocks is illustrative only and the order of the blocks can change according to the present disclosure. Additional blocks may be added or fewer blocks may be utilized, without deviating from the scope of the present disclosure. The method 200 can begin at block 202.

At block 202, at least a portion of one or more refrigerant streams is received by one or more refrigerant accumulators 26, 27,28. At block 204, the one or more refrigerant streams is separated by the one or more refrigerant accumulator 26, 27, 28 into a predominately vapor portion and a predominately liquid portion. At block 206, the predominately vapor portion is withdrawn from the one or more refrigerant accumulators 26, 27, 28 via a first conduit. At block 208, the predominately liquid portion is withdrawn from the one or more refrigerant accumulators 26, 27, 28 via a second conduit.

Such a method is more efficient and cost-effective compared to conventional methods. It will be appreciated by those skilled in the art that changes could be made to the implementations described above without deviating from the scope of the present disclosure. For instance, it is foreseen that any one or more of the blocks and/or description of the method 200 may be interchangeable, omitted therefrom, and/or added thereto, without deviating from the scope of the present disclosure. It is understood, therefore, that the present disclosure herein is not limited to the particular implementations disclosed and is intended to cover modifications within the spirit and scope of the present disclosure.

The disclosures shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the implementations described above may be modified within the scope of the appended claims.

For instance, chillers and economizers may be interchanged by a person of ordinary skill in the art dependent upon the available feeds & temperatures required. A chiller may use a kettle or vessel with a liquid refrigerant to cool or condense a process feed. Alternatively, an economizer may use cold gases to chill a process feed. In one implementation, a chiller may use a liquid propane or propylene refrigerant to cool or condense a process feed gas. In another implementation, a chiller may use a liquid ethane or ethylene refrigerant to cool or condense a process feed gas. In yet another implementation, an economizer may use a cold ethane or ethylene gas to cool or condense a process feed gas. In another embodiment, an economizer may use a cold methane gas to cool or condense a process feed gas. A variety of combinations may be utilized where liquid refrigerants may be selected from propane, propylene, ethane, ethylene, methane, or other liquid refrigerant may be used in a chiller to cool or condense a process feed gas; or where cold gases selected from propane, propylene, ethane, ethylene, methane or other chilled gas may be used in an economizer to cool or condense a process feed gas. In some implementations, a pure component refrigerant or gas may be used, said pure component refrigerant or gas being greater than 90%, greater than 95% or greater than 99% pure refrigerant or gas.

What is claimed is:

1. A system comprising:
refrigerant accumulator operable to receive a refrigerant;
a plurality of pipes of the refrigerant accumulator;
a first portion of the plurality of pipes disposed on a first plane and operable to receive the refrigerant to separate the refrigerant into a first refrigerant portion and a second refrigerant portion, the first refrigerant portion comprising vapor and the second refrigerant portion comprising liquid; and
a second portion of the plurality of pipes disposed on a second plane and operable to receive the first refrigerant portion.

2. The system of claim 1, wherein the first plane is spaced from the second plane.

3. The system of claim 2, wherein the first plane is parallel to the second plane.

4. The system of claim 2, wherein the first plane is vertically spaced from the second plane.

5. The system of claim 2, wherein the plurality of pipes include a third portion that connects the first and second portions of the plurality of pipes.

6. The system of claim 5, wherein the third portion of the plurality of pipes is disposed in a third plane.

7. The system of claim 6, wherein the third plane is arranged perpendicular to at least one of the first plane or the second plane.

8. The system of claim 1 further comprising:
a first conduit; and
a second conduit.

9. The system of claim 8, wherein the first refrigerant portion is operable to be withdrawn from the refrigerant accumulator via the first conduit.

10. The system of claim 8, wherein the second refrigerant portion is operable to be withdrawn from the refrigerant accumulator via the second conduit.

11. The system of claim 1, wherein the refrigerant includes at least one of propane or ethylene.

12. A method for separating a refrigerant stream, the method comprising:
receiving a portion of a refrigerant stream by a refrigerant accumulator;
separating the refrigerant stream by the refrigerant accumulator into a first refrigerant portion and a second refrigerant portion, the first refrigerant portion comprising vapor and the second refrigerant portion comprising liquid;
withdrawing the first refrigerant portion from the refrigerant accumulator via a first conduit; and
withdrawing the second refrigerant portion from the refrigerant accumulator via a second conduit.

13. The method of claim 12, wherein the refrigerant accumulator comprises a first portion of a plurality of pipes disposed on a first plane.

14. The method of claim 13, wherein the refrigerant accumulator comprises a second portion of the plurality of pipes disposed on a second plane.

15. The method of claim 14, wherein the first plane is parallel to the second plane.

16. The method of claim 14, wherein the plurality of pipes include a third portion that connects the first and second portions of the plurality of pipes, the third portion disposed on a third plane.

17. The method of claim 16, wherein the third plane is arranged perpendicular to at least one of the first plane or the second plane.

18. The method of claim 12, wherein the refrigerant stream includes at least one of propane or ethylene.
